(19) United States
(12) Patent Application Publication
(10) Pub. No.: US 2009/0126846 A1
(43) Pub. Date: May 21, 2009

(54) Tire And Method Of Building Tire

(75) Inventor: Hiroshi Tada, Osaka (JP)

Correspondence Address: FISH & RICHARDSON P.C., P.O. BOX 1022, MINNEAPOLIS, MN, 55440-1022, US

(73) Assignee: TOYO TIRE & RUBBER CO., LTD., Osaka (JP)

(21) Appl. No.: 12/269,106

(22) Filed: Nov. 12, 2008

(30) Foreign Application Priority Data
Nov. 19, 2007 (JP) 2007-299235

(51) Int. Cl. B60C 9/20; B29D 30/08

(52) U.S. Cl. 152/526; 156/117

(57) ABSTRACT

A tire, in which excessively overlapping portions can be made small and excessively overlapping portions on a winding beginning side and on a winding terminating side are not present in the same cross sectional position in a width direction and which is good in tire weight balance and can improve RFV. In the case where a rubber strip material is wound in a first round on a winding beginning side without being inclined in a tire circumferential direction, wound in a second round and after in a state of being inclined to the tire circumferential direction so that feed of a predetermined pitch in a tire width direction is given every round in a part of a region in the tire circumferential direction, wound in the remaining part of the region without being inclined, and wound in a final round on a winding terminating side without being inclined in the tire circumferential direction, phases of the rubber strip material in the second round and after in an inclined region every round are successively shifted in a direction, in which inclination begins a little early every round.

### BACKGROUND OF THE INVENTION

1. Field of the Invention

The present invention relates to a tire structured to include a plurality of rubber members for tire and a method of building the tire.

2. Description of the Related Art

Generally, a pneumatic tire (referred below to as tire) is structured to include a plurality of rubber members for tire. Typically, as shown in FIG. 5, respective parts such as an inner liner 2, a tread 3, side walls 4, rim strips 5, etc. are formed from rubber members, which meet respective characteristics as demanded, and such rubber members are combined with tire reinforcement members such as a carcass 6, a belt 7, etc. to form a tire T.

In recent years, a rubber member having a predetermined cross section is built by spirally overlapping and winding a non-cured rubber strip material, which is subjected to extrusion molding in a ribbon-shape, on a rotary support body such as building drum or the like in a tire circumferential direction (see, for example, JP-A-9-29858 and JP-A-2003-305781).

Also, when a rubber strip material is spirally overlapped and wound as in JP-A-9-29858 and JP-A-2003-305781, surplus rubber portions projecting on both left and right ends are produced and cut treatment is needed after winding, so that it is proposed to perform winding in parallel to a tire circumferential direction perpendicular to a tire width direction in a first round on a winding beginning side and in a final round on a winding terminating side and to perform spiral winding in other wound portions in a second round and after so as to give feed of one pitch in one round (see, for example, JP-A-2002-205512).

Further, since according to the winding system described above, an amount of rubber as wound increases in a first round or several rounds on a winding beginning side and in a final round or several rounds on a winding terminating side to have serious influences on tire weight balance and tire uniformity, it is proposed with a view to solving this to perform winding in a first round at the start of winding in a winding beginning position in a tire circumferential direction, to perform winding every round in a state of inclining to the tire circumferential direction so as to give feed of a predetermined pitch in a partial region in the tire circumferential direction, to perform winding in other portions except the inclined region in the tire circumferential direction, and to perform winding contiguous to the inclined region in a final round on a winding terminating side in the tire circumferential direction to provide for termination over the inclined region without inclination (JP-A-2006-69130).

By the way, a rubber strip material 101 is wound, as shown in FIG. 6, in the winding system of JP-A-2006-69130. Therefore, triangular-shaped, excessively overlapping portions Q1, Q2 of the rubber strip material are produced in inclined regions G on a winding beginning side and a winding terminating side of the rubber strip material 101 and in the phase portion of the inclined regions G of winding, the number of layers generated by orbital movements of the rubber strip material 101 increases one layer relative to the remaining phase portion in a cross section taken in a width direction of the line VII-VII (see FIG. 7) and perpendicular to a tire circumferential direction, so that such excessively overlapping portions Q1, Q2 are responsible for deterioration in weight balance in the tire circumferential direction. Also, a total thickness of the rubber strip material 101 increases in the width direction cross section to be responsible for deterioration in RFV (Radial-Force-Variation).

The invention has been thought of in view of the above and has its object to provide a tire, which is structured to include a plurality of rubber members for tire, and in which when at least one of the rubber members is built by winding of a ribbon-shaped rubber strip material, excessively overlapping portions can be decreased as far as possible and, in particular, excessively overlapping portions on a winding beginning side and on a winding terminating side are not present in the same cross sectional position in a width direction and which tire is good in tire weight balance and can improve RFV, and a method of building a tire.

### SUMMARY OF THE INVENTION

The invention, which solves the problem described above, provides a tire structured to include a plurality of rubber members for tire, at least one of which rubber members is built by partially overlapping and winding a ribbon-shaped rubber strip material in a tire circumferential direction, and wherein the rubber strip material is wound in a first round on a winding beginning side without being inclined in a tire circumferential direction, inclined to the tire circumferential direction and wound in a second round and after so that feed of a predetermined pitch in a tire width direction is given every round in a part of a region in the tire circumferential direction, wound in the remaining portion except the inclined region without being inclined in the tire circumferential direction, and wound in a final round on a winding terminating side without being inclined in the tire circumferential direction, and phases of the rubber strip material in a second round and after in the inclined region are successively shifted every round in a direction, in which inclination begins a little early every round.

With the tire constructed in this manner, phases of the rubber strip material every round in the inclined region are inclined to a direction perpendicular to a circumferential direction whereby excessively overlapping portions of the rubber strip material in the inclined region on a winding beginning side and on a winding terminating side are shifted in the tire circumferential direction to be arranged in a wide range to enable to inhibit an increase in the number of layers, which is caused by round of the rubber strip material, in a cross section in a width direction perpendicular to the tire circumferential direction, so that it is possible to decrease influences on weight balance of a tire and RFV.

Also, by inclining phase of the inclined region in the manner described above, excessively overlapping portions of the rubber strip material on a winding beginning side and excessively overlapping portions on a winding terminating side in the inclined region are shifted in the circumferential direction so as not to overlap each other in the cross section in the width direction whereby excessively overlapping portions on a winding beginning side and on a winding terminating side are not present overlapping each other in the cross section in the width direction perpendicular to the tire circumferential direction, so that the number of layers produced by round of the rubber strip material is made substantially the same in all the phases to eliminate degradation in tire weight balance, thus enabling to improve RFV.

Preferably, a magnitude of shift of the rubber strip material every round is in the angular range of 1.50° to 2.70°. Thereby, it is possible to decrease a magnitude, by which both excessively overlapping portions on a winding beginning side and on a winding terminating side overlap each other in the inclined region, thus enabling surely to shift phases of the both excessively overlapping portions in a circumferential direction.

The second invention provides a method of building a tire structured to include a plurality of rubber members for tire, the method comprising the steps of partially overlapping and winding a ribbon-shaped rubber strip material in a tire circumferential direction to build at least one of the rubber members, in which winding and building step the rubber strip material is wound in a first round on a winding beginning side without being inclined in a tire circumferential direction, inclined to the tire circumferential direction and wound in a second round and after so that feed of a predetermined pitch in a tire width direction is given every round in a part of a region in the tire circumferential direction, wound in the remaining portion except the inclined region without being inclined in the tire circumferential direction, and wound in a final round on a winding terminating side without being inclined in the tire circumferential direction, and timing, in which inclination of the rubber strip material begins in a second round and after, is quickened every round to successively shift phases of the inclined region circumferentially.

Thereby, unnecessary overlapping portions of the rubber strip material are made small and the inclined region is shifted in phase whereby portions, in particular, excessively overlapping portions on a winding beginning side and on a winding terminating side are positionally shifted in the circumferential direction, thus enabling to obtain a tire of the invention, which is good in weight balance as a whole and can improve RFV.

In the winding and building step, the rubber strip material is wound by rotation of a predetermined rotary support body while being supplied to the rotary support body, and control is exercised to move supply means of the rubber strip material relative to the rotary support body in a width direction to incline and wind the rubber strip material so as to give a predetermined pitch in the width direction while timing, in which movement of the rubber strip material begins in a second round and after, is quickened every round to give feed in a portion of a rotating angle corresponding to the inclined region. Thereby, it is possible to automate a winding system, in which an inclined region of winding of a rubber strip material, in particular, an inclined region with phases successively shifted is set partially in the tire circumferential direction, thus enabling an increase in productivity.

According to the tire of the invention and a method of building the same, in winding a ribbon-shaped rubber strip material for rubber members, which constitute a tire, phases of inclined regions of the rubber strip material every round in a second round and after are successively shifted in a direction, in which inclination begins a little early every round, whereby excessively overlapping portions are present slightly at ends of the rubber strip material on a winding beginning side and on a winding terminating side and besides the excessively overlapping portions of the rubber strip material are present shifting in the circumferential direction. Therefore, it is possible to improve RFV without impairing the whole tire in weight balance and uniformity.

### BRIEF DESCRIPTION OF THE DRAWINGS

FIG. 1 is a schematic, front view showing an embodiment of the invention and illustrating a state, in which a ribbon-shaped rubber strip material is wound according to the invention;

FIG. 2 is a view schematically showing, in planar development, the rubber strip material having gone round several times on a winding beginning side and the rubber strip material having gone round several times on a winding terminating side;

FIG. 3 is a cross sectional view taken along the line III-III in FIG. 2;

FIG. 4 is a schematic view illustrating a method of winding a ribbon-shaped rubber strip material extruded and supplied from supply means, such as extruder, etc. to build a rubber member;

FIG. 5 is a cross sectional view illustrating a tire structure;

FIG. 6 is a view schematically showing, in planar development, a rubber strip material having gone round several times on a winding beginning side and a rubber strip material having gone round several times on a winding terminating side in a conventional configuration of winding; and

FIG. 7 is a cross sectional view taken along the line VII-VII in FIG. 2.

### DESCRIPTION OF THE PREFERRED EMBODIMENT

Subsequently, a mode for carrying out the invention will be described on the basis of an embodiment shown in the drawings.

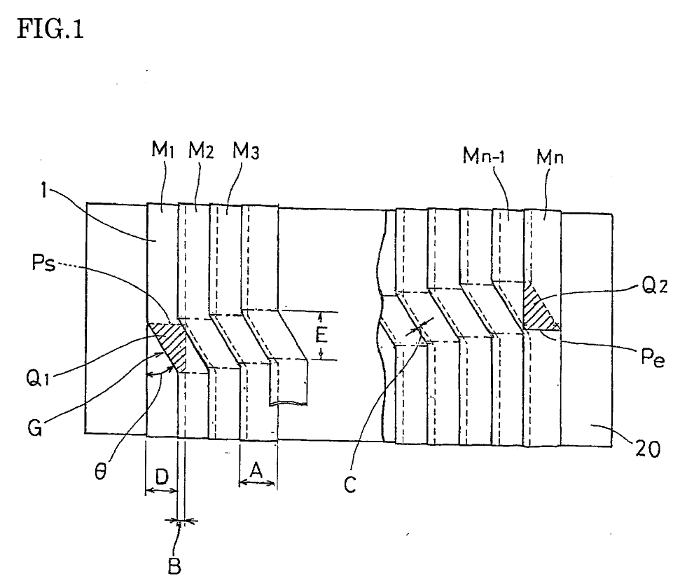

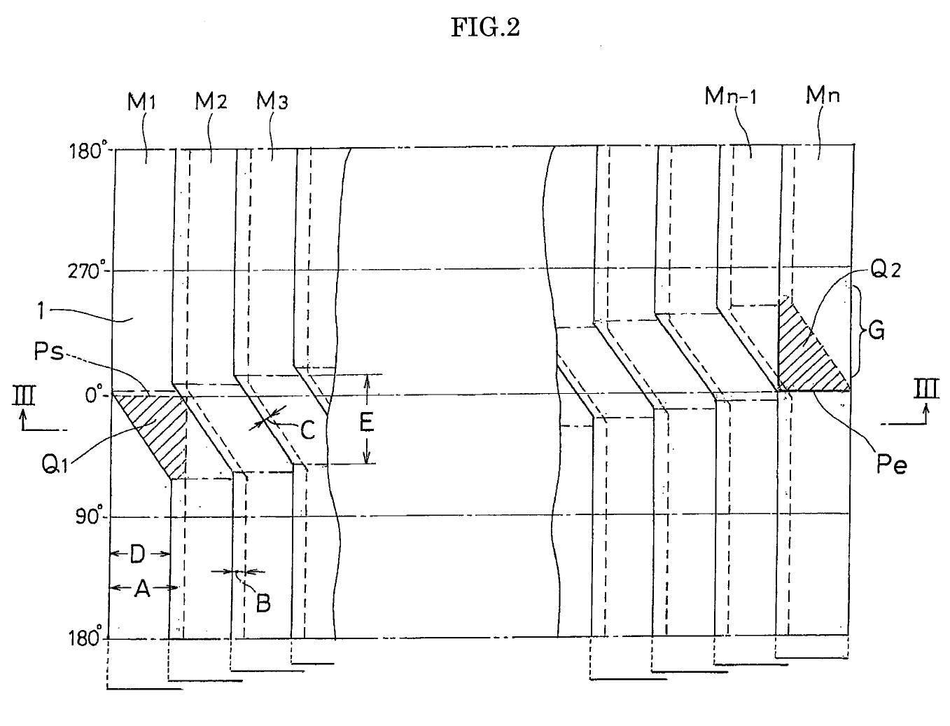

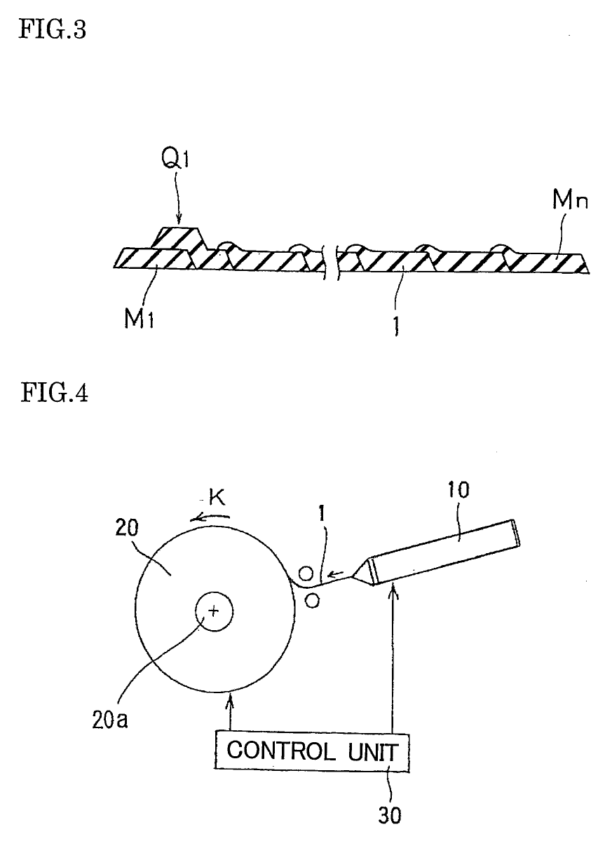

FIG. 1 is a schematic, front view illustrating a state, in which a ribbon-shaped rubber strip material is wound according to the invention, and FIG. 2 is a view schematically showing, in planar development, the rubber strip material having gone round several times on a winding beginning side and the rubber strip material having gone round several times on a winding terminating side. FIG. 3 is a cross sectional view taken along the line III-III in FIG. 2.

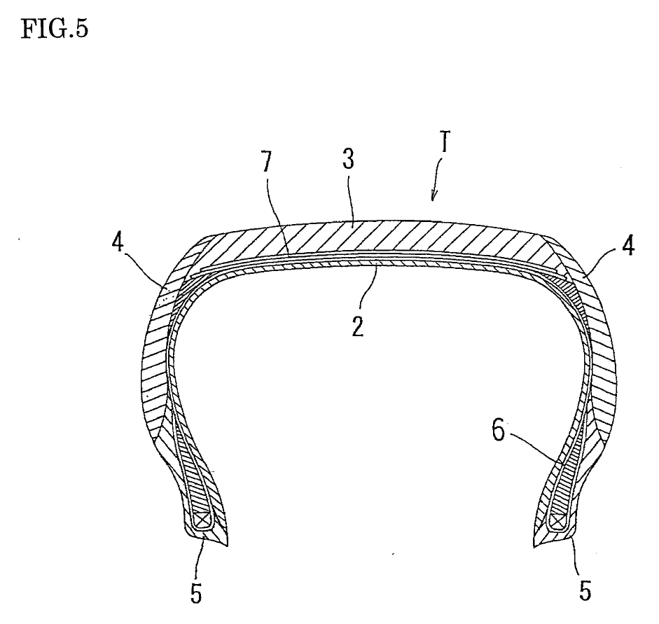

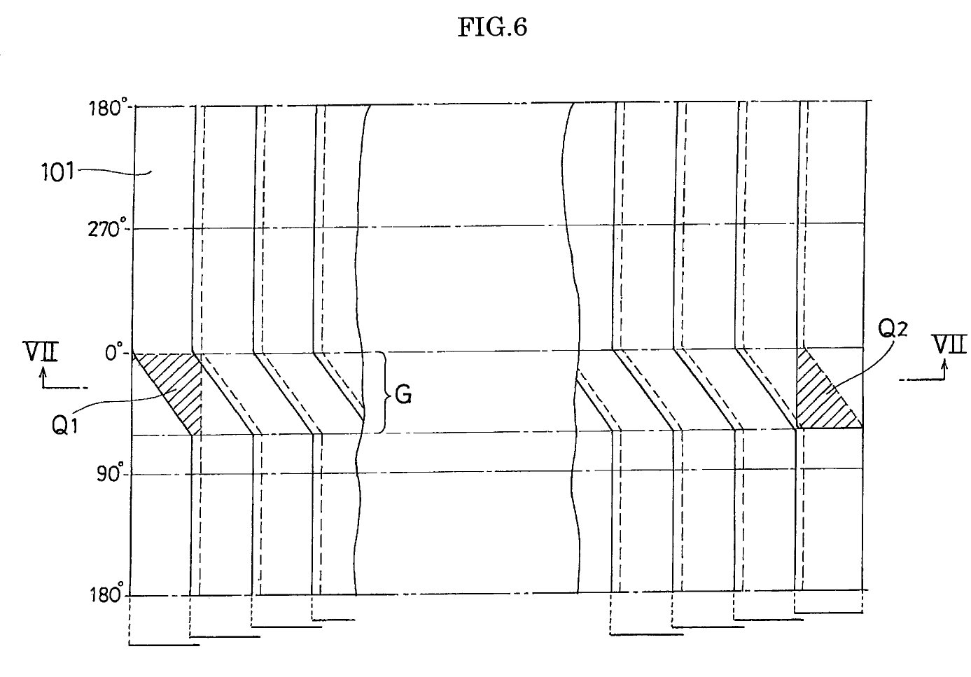

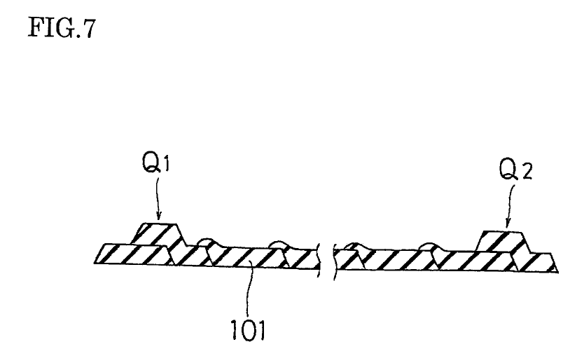

As shown in FIG. 5, a tire T according to the invention comprises, in its fundamental constitution, a plurality of tire rubber members such as an inner liner 2, a tread 3, side walls 4, rim strips 5, etc., and is constructed by combining the rubber members with tire reinforcement members such as a carcass 6, a belt 7, etc. This is the same as conventional tires.

At least one, preferably, plural or all out of a plurality of rubber members, which constitute the tire T, are built in a building process in tire manufacture by overlapping and winding a part of a ribbon-shaped rubber strip material 1, which is extrusion-molded in a lengthy magnitude by feeder means such as an extruder or the like, in a tire circumferential direction.

The cross sectional shape of the rubber strip material 1 is usually shaped variously, such as ribbon-shaped, for example, substantially crescent-shaped, or flat and substantially triangular-shaped, or flat and substantially trapezoidal-shaped in relatively flat cross section to be maximum in thickness at a center thereof in a width direction and to be gradually decreased in thickness toward both ends from the center, according to a configuration of a rubber member being built. The rubber strip material may be flat and ribbon-shaped to have the same thickness over a total width thereof. Practically, a rubber strip material being relatively flat and ribbon-shaped and ranging to have a width A of 5 to 70 mm, a thickness of 0.5 to 5.0 mm at a center thereof in a width direction, and a thickness of 0.05 to 0.2 mm at both ends in the width direction is preferably used as the rubber strip material 1.

Referring to the drawings, a configuration, in which the rubber strip material 1 is wound, will be described taking, as an example, the case where a rubber member as the inner liner 2 on, for example, the tire T shown in FIG. 5 is wound and built.

FIG. 4 is a schematic view showing a fundamental construction of an apparatus for winding of the rubber strip material 1 and the case where supply means 10, such as extruder, etc., for the rubber strip material 1 is mounted in opposition to a rotary support body 20 such as building drum or the like and the rubber strip material 1 having a predetermined cross section and supplied in a ribbon manner from the supply means 10 is supplied directly onto the rotary support body 20 to be wound. The rotary support body 20 can rotate about a shaft 20a and the rubber strip material 1 is wound in a tire circumferential direction as shown in FIGS. 1 and 2 while the rotary support body 20 is rotated in K direction shown in FIG. 4.

In the example shown in FIGS. 1 to 3, an overlap margin B of the rubber strip material 1 is made about 1/10 times a width A of the rubber strip material 1 and a state, in which winding is performed rightward from leftward. In the figure, a first round at the start of winding is denoted M₁, second round is denoted M₂, a third round is denoted M₃, - - - , a (n−1)th round is denoted M₍ₙ₋₁₎, and a n-th round, that is, a final round is denoted Mₙ.

As shown in FIGS. 1 and 2, winding is performed in parallel to the tire circumferential direction perpendicular to a tire width direction in the first round M₁ at the start of winding of the rubber strip material 1. Pₛ denotes a position, in which winding is started. Subsequent to the first round M₁, winding is performed obliquely to the tire circumferential direction in the second round M₂ and after so that feed of a predetermined pitch D corresponding to the overlap margin B in the tire width direction is given every round of winding in the regions G of a predetermined length (predetermined angle) in the tire circumferential direction, and winding in parallel to the tire circumferential direction perpendicular to the tire width direction is performed in positions sequentially shifted due to the inclination for the remaining region except the inclined regions G. θ in the figures denotes the angle of inclination.

Further, in the final round Mₙ succeeding the inclined region G on the winding terminating side, winding in parallel to the tire circumferential direction perpendicular to the tire width direction is performed succeeding the inclined regions G, and termination is made in a position, in which inclination of the inclined region G is terminated, or in the vicinity thereof, preferably, slightly beyond the inclination terminated position without inclining its terminating end. Pₑ in the figures denotes a position, in which winding is terminated.

In particular, according to the invention, phases of the rubber strip material 1 in the second round and after in the inclined region G every round are successively shifted in a direction, in which inclination begins a little early every round whereby phases of the rubber strip material 1 in the inclined region G every round are inclined to a direction perpendicular to the tire circumferential direction and excessively overlapping portions Q1, Q2 in the inclined region G on a winding beginning side and on a winding terminating side are arranged to be shifted in the tire circumferential direction.

That is, the excessively overlapping portion Q1 of the rubber strip material 1 on a winding beginning side and the excessively overlapping portion Q2 on a winding terminating side in the inclined regions G are arranged to be shifted circumferentially so as not to overlap each other in a cross section in a width direction whereby the excessively overlapping portions Q1, Q2 on the winding beginning side and on the winding terminating side are not overlappingly present in a cross section in a width direction perpendicular to the tire circumferential direction. In practice, a winding beginning position Pₛ and a winding terminating position Pₑ of the rubber strip material 1 are preferably positioned substantially corresponding to each other in the width direction perpendicular to the tire circumferential direction.

While shift of phases of the rubber strip material 1 in a direction, in which inclination begins a little early every round, differs according to a width A of the rubber strip material 1, feed pitch D of winding, the number of total rounds, etc., it is usually set in the range of 1.50° to 2.70° in terms of a rotating angle, preferably, around 2.25° and set so that the excessively overlapping portion Q1 of the inclined region G on a winding beginning side and the excessively overlapping portion Q2 of the inclined region G on a winding terminating side are positioned and shifted by an angle or more in the range of a circumferential length of the inclined region G.

For example, when phases are shifted in the range of 1.50° to 2.70° of the shift and the number of rounds is 20, shift corresponding to a rotating angle of 30° to 54° relative to a winding beginning end is generated at a winding terminating end of the inclined region G, so that even when a circumferential length of the inclined region is in the angular range of 30°, the excessively overlapping portions Q1, Q2 on the winding beginning side and on the winding terminating side are not overlappingly present in a cross section in the width direction perpendicular to the tire circumferential direction.

When the rubber strip material 1 is to be wound, the rotary support body 20 is rotated and the supply means 10 is moved relative to the rotary support body 20 in a tire width direction shown in FIG. 4 so that feed of a predetermined pitch D in a width direction is given in a portion of a rotating angle corresponding to the inclined region G every round in winding of the second round and after. Therefore, at least one of the supply means 10 and the rotary support body 20 is moved in the tire width direction. That is, it is possible to move the supply means 10 relative to the rotary support body 20, to move the rotary support body 20 relative to the supply means 10 in a width direction, or to relatively move the both in the width direction. Movement in the width direction and rotation of the rotary support body 20 make it possible to incline the rubber strip material 1 in the inclined region G.

In particular, according to the invention, at the time of winding, phases of the inclined region G are successively shifted in a circumferential direction by making timing, in which inclination begins, a little early every round of the rubber strip material 1 in the second round M₂ and after. Therefore, control is exercised to move the supply means 10 of the rubber strip material 1 relative to the rotary support body 20 in the width direction while making timing, in which movement begins, a little early in a part of a rotating angle corresponding to the inclined region G, and the rubber strip material 1 is wound while being inclined in a manner to give feed of a predetermined pitch D in the width direction and shifting phases of the inclined region G. At this time, an angle θ of inclination of the inclined region G can be appropriately set by regulating the rotating speed of the rotary support body 20, in particular, the rotating speed of an outer peripheral portion (wound portion) thereof in a circumferential direction and the speed of relative movement in the width direction.

Also, the supply means 10 is controlled in the remaining part (part in parallel to the tire circumferential direction) of a rotating angle except the inclined region G in the second round M₂ and after so as not to move relative to the rotary support body 20 in the tire width direction, whereby winding in parallel to the tire circumferential direction can be performed. For the first round M₁ and the final round Mₙ, winding in the tire circumferential direction can be performed by controlling the supply means 10 not to move the same relative to the rotary support body 20 in the tire width direction.

A control unit 30 shown in FIG. 4 exercises respective controls for the supply means 10 and the winding operation of the rotary support body 20, and in particular, exercises control to make timing of feeding movement early in order to shift phases of the inclined region G.

While shifts (rotating angle) of phases of the inclined region G in winding of the rubber strip material 1 is set in the manner described above, respective conditions such as the width A of the rubber strip material 1, the overlap margin B, an overlap margin C in the inclined region G, the feed pitch D in the width direction, a length E of the inclined region G in the tire circumferential direction, the angle θ of inclination, etc. are appropriately set according to a kind and a configuration of rubber members for tire being built to afford winding and building.

For example, the angle θ of inclination is made equal to or less than 45°. That is, the larger the angle θ of inclination, the larger deformation on continuous portions in the tire circumferential direction and in a direction of inclination in winding the rubber strip material 1, and in particular, when the angle 45° of inclination is exceeded, winding (stick in a partially overlapping state) becomes difficult and the object cannot be attained. In addition, when the angle θ of inclination is made small, a length E of the inclined region G in the tire circumferential direction increases in association with the width A of the rubber strip material 1 and the overlap margin B, so that it is preferable to set the angle θ so as not to make the length E excessively large.

Also, while the length E of the inclined region G in the tire circumferential direction in inclining the rubber strip material 1 to give feed of a predetermined pitch D can be set according to the width A of the rubber strip material 1, the overlap margin B, the winding pitch D in the width direction, and the angle θ of inclination, an effect of reduction in influences on weight balance and uniformity cannot be fairly produced as the length E increases, so that it is preferable to set the length to at most 1/5 times a length of one round, preferably, 1/10 or less, more preferably, five times the width A of the rubber strip material 1 or less as far as short. However, when the length E becomes too small, the angle θ of inclination is increased depending upon the width A of the rubber strip material 1, the overlap margin B, and the pitch D to make winding difficult in some cases, so that it is practically preferable to set the length E so as not to make the angle θ of inclination exceed 45° and to set the length in the range of 1/5 times the width A of the rubber strip material 1 or more but 5 times or less.

Also, the overlap margin B of the rubber strip material 1 is usually set in the range of 4/5 to 1/10 times the width A of the rubber strip material 1 and the feed pitch D in the width direction, that is, feed in the width direction in the inclined region G is made 1/5 to 9/10 times the width A of the rubber strip material corresponding to the overlap margin B. In the case where the overlap margin B is, for example, 1/5 times the width A, the feed pitch D will amount to 4/5 times the width A. In addition, the overlap margin B is outside the range in some cases.

Given the overlap margin B and the angle θ of inclination for the width A (5 to 70 mm) of a rubber strip material 1 as used, it is possible to determine the length E of the inclined region G in the tire circumferential direction, the overlap margin C in the inclined region G, the feed pitch D in the width direction, etc. The overlap margin B and the angle θ of inclination are controlled by using the control unit 30 to control the speeds of relative movements of the supply means 10 and the rotary support body 20 in the tire width direction and magnitudes of movements.

The following TABLE 1 indicates comparison of RFV between a tire (Embodiment 1 and Embodiment 2) built by carrying out the winding system of the invention, in which a ribbon-shaped rubber strip material having a width of 52 mm and a thickness of 2 mm was used and phases of inclined regions were shifted, and a tire (Comparative example 1 and Comparative example 2) built by carrying out the winding system, which is disclosed in JP-A-9-29858 and in which the same strip material was used and phases of inclined regions were not shifted. In TABLE 1, Embodiment 1 corresponds to Comparative example 1 and Embodiment 2 corresponds to Comparative example 2. In addition, all other constituent members except an inner liner of a tire were made the same.

Tires as tested had specifications such as tire size: LT325/60R20, rim: 20×10J, internal pressure: 2.0 kg/cm², and the measuring method of RFV was carried out for the weight of 900 kgf and conformed to the measuring method prescribed JIS D4233.

TABLE 1

| | COMPARATIVE | COMPARATIVE | EMBODIMENT | EMBODIMENT |
|---|---|---|---|---|
| | EXAMPLE 1 | EXAMPLE 2 | 1 | 2 |
| STRIP MATERIAL WIDTH (mm) | 52 | 52 | 52 | 52 |
| OVERLAP MARGIN (mm) | 8 | 12.7 | 8 | 12.7 |
| OVERLAP MARGIN OF INCLINED REGION (mm) | 7.8 | 12.5 | 7.8 | 12.5 |
| FEED PITCH (mm) | 44 | 39.3 | 44 | 39.3 |
| LENGTH OF INCLINED REGION (mm) | 173 | 173 | 173 | 173 |
| ANGLE OF INCLINATION (°) | 14.3 | 12.8 | 14.3 | 12.8 |
| SHIFT OF PHASE (°) | — | — | 2.5 | 2.1 |
| RFV (kgf) | 16.5 | 14.3 | 14.4 | 11.4 |
| IMPROVEMENT RATE | | | 12.6% | 19.9% |

In TABLE 1, according to both Embodiment 1 and Embodiment 2, phases of the inclined region G are successively shifted in a direction, in which inclination begins a little early every round, and inclined to a direction perpendicular to a circumferential direction whereby excessively overlapping portions of a rubber strip material in inclined regions on a winding beginning side and on a winding terminating side are shifted in a tire circumferential direction to be arranged in a wide range, with the result that influences on weight balance of a tire can be reduced and RFV is improved as compared with a conventional winding system, in which phases are not shifted.

Accordingly, tire performances such as weight balance, RFV, etc. can be maintained favorable by winding a rubber strip material 1 and building respective rubber members as in the invention.

In addition, while the case where a rubber strip material 1 extruded from the supply means 10 such as extruder, etc. to be built is supplied to the rotary support body 20 such as building drum or the like simultaneously with building to be wound is shown in the explanation of the building method, it is possible to subject the rubber strip material to extrusion molding in a separate process from the winding process to transfer the same to the winding process to continuously supply the same onto the rotary support body through a supply device to achieve winding and building.

The invention can be preferably made use of in the case where a tire is manufactured by winding a ribbon-shaped and non-cured rubber strip material onto a rotary support body such as building drum or the like in a tire circumferential direction to build a tire rubber member.

What is claimed is:

1. A tire structured to include a plurality of rubber members for tire, at least one of which rubber members is built by partially overlapping and winding a ribbon-shaped rubber strip material in a tire circumferential direction, and
wherein the rubber strip material is wound in a first round on a winding beginning side without being inclined in a tire circumferential direction, inclined to the tire circumferential direction and wound in a second round and after so that feed of a predetermined pitch in a tire width direction is given every round in a part of a region in the tire circumferential direction, wound in the remaining portion except the inclined region without being inclined in the tire circumferential direction, and wound in a final round on a winding terminating side without being inclined in the tire circumferential direction, and
phases of the rubber strip material in a second round and after in the inclined region are successively shifted every round in a direction, in which inclination begins a little early every round.

2. The tire according to claim 1, wherein an excessively overlapping portion of the rubber strip material on a winding beginning side and an excessively overlapping portion on a winding terminating side in the inclined region are shifted circumferentially so as not to overlap each other in a cross section in a width direction.

3. The tire according to claim 1 or 2, wherein a magnitude of shift of the rubber strip material every round is in the angular range of 1.50° to 2.70°.

4. A method of building a tire structured to include a plurality of rubber members for tire, the method comprising the steps of
partially overlapping and winding a ribbon-shaped rubber strip material in a tire circumferential direction to build at least one of the rubber members, in which winding and building step the rubber strip material is wound in a first round on a winding beginning side without being inclined in a tire circumferential direction, inclined to the tire circumferential direction and wound in a second round and after so that feed of a predetermined pitch in a tire width direction is given every round in a part of a region in the tire circumferential direction, wound in the remaining portion except the inclined region without being inclined in the tire circumferential direction, and wound in a final round on a winding terminating side without being inclined in the tire circumferential direction, and
timing, in which inclination of the rubber strip material begins in a second round and after, is quickened every round to successively shift phases of the inclined region circumferentially.

5. The method of building a tire, according to claim 4, wherein in the winding and building step, the rubber strip material is wound by rotation of a predetermined rotary support body while being supplied to the rotary support body, and control is exercised to move supply means of the rubber strip material relative to the rotary support body in a width direction to incline and wind the rubber strip material so as to give feed of a predetermined pitch in the width direction
while timing, in which movement of the rubber strip material begins in a second round and after, is quickened every round to give feed in a portion of a rotating angle corresponding to the inclined region.
